(19) United States
(12) Patent Application Publication
(10) Pub. No.: US 2026/0237176 A1
(43) Pub. Date: Aug. 13, 2026

(54) METHOD AND COMPUTING APPARATUS FOR DISPLAYING AN OPERATION ASSISTANCE SCREEN OF PRECISION MACHINING EQUIPMENT

(71) Applicant: SAMSUNG ELECTRONICS CO., LTD., Suwon-si (KR)

(72) Inventor: So Yeon LEE, Suwon-si (KR)

(73) Assignee: SAMSUNG ELECTRONICS CO., LTD., Suwon-si (KR)

(21) Appl. No.: 19/332,603

(22) Filed: Sep. 18, 2025

(30) Foreign Application Priority Data
Feb. 11, 2025 (KR) 10-2025-0017187

(51) Int. Cl. G06V 10/22; G06F 9/451; G06V 10/25

(52) U.S. Cl. CPC G06V 10/235; G06F 9/453; G06V 10/25

(57) ABSTRACT

Method and apparatus for generating a real-time operation assistance screen for precision machining equipment is provided. Method may include receiving user input to designate a region of interest and select one or more execution target recipes; capturing, in real time, an image on the display displaying the operation UI of the precision machining equipment and associated with the region of interest; generating a real time assistance screen of the precision machining equipment based on the captured image of the region of interest and the execution target recipe; and displaying the generated real-time assistance screen on the display. In embodiments, the real-time assistance screen includes real-time assistance output based on an analysis of the input image and the execution target recipe, and the capturing, the generating, and the displaying the generated screen include no direct information exchange with a program associated with the operation UI of the precision machining equipment.

### CROSS-REFERENCE TO RELATED APPLICATION

This application claims priority from Korean Patent Application No. 10-2025-0017187 filed on Feb. 11, 2025, in the Korean Intellectual Property Office and all the benefits accruing therefrom under 35 U.S.C. 119, the contents of which in its entirety are herein incorporated by reference.

### BACKGROUND

### 1. Field

The present disclosure relates to a method for generating and/or displaying an operation assistance screen of precision machining equipment and a computing apparatus that performs the method.

### 2. Description of the Related Art

A technology for manufacturing thin pieces for TEM (Transmission Electron Microscopy) analysis using a focused ion beam (FIB) is widely utilized in analyzing semiconductors and microelectronic components. In the related art, a generally used method includes an operator directly operating an FIB device manually to machine a sample. That is, an operator manually operates a machine to cut a thin piece at a desired location and machined to a specific thickness.

For example, the operator may manufacture a thin piece, by controlling a precision machining equipment 20 connected to the computing apparatus for controlling precision machining equipment by the use of a computing apparatus 10 for controlling precision machining equipment shown in FIG. 1. The precision machining equipment 20 may be, for example, an FIB. The operator operates the precision machining equipment, by inputting operation commands through an operation UI (User Interface) of an exemplary precision machining equipment as in FIG. 2. The operation UI 100 may be provided by an operation program that transmits and receives data to and from the precision machining equipment 20. The operation UI 100 may include, for example, captured image monitoring panels 110, 120, 130, 140 and a control panel 150. The control panel 150 may include a region for displaying analytical information received from the precision machining equipment 20 and a region for inputting operation commands for the precision machining equipment 20.

The process of manufacturing a thin piece using the FIB requires a high level of skill, and the quality of the result is greatly influenced by the skill level of the operator. In particular, the experience and sense of a skilled operator are indispensable in the process of precisely cutting a specific part of a specimen and uniformly machining it to a desired thickness. As a result, even if the same apparatus is used, the machining speed, quality, and reproducibility may vary depending on the operator.

A problem in ensuring stable productivity of thin piece manufacturing occurs due to such limitations of the related art. When performed by an operator with low skill level, there is a high likelihood that the thickness of the thin piece is not constant or accurate cutting is not performed at the desired position. In addition, when manufacturing a thin piece using the FIB requires a lot of time, there is a risk that the operator's fatigue level increases and the machining accuracy decreases. For this reason, there is an increasing need for a technology that provides an operation assistance screen that is useful for operating the precision machining equipment for a task which requires a high precision, such as thin piece manufacturing.

### SUMMARY

Aspects of the present invention provide a method for providing an operation assistance screen to a user who operates precision machining equipment and a computing apparatus to which the method is applied.

Aspects of the present invention also provide a method for providing an operation assistance screen to a user who operates precision machining equipment without directly receiving any information from the precision machining equipment and a computing apparatus to which the method is applied.

Aspects of the present invention also provide a method for providing an operation assistance screen to a user who operates precision machining equipment without directly receiving any information from an operation program connected to the precision machining equipment and a computing apparatus to which the method is applied.

Aspects of the present invention also provide a method for providing an operation assistance screen that provides an editing tool so that a user may freely define logic for generating information to be displayed on the operation assistance screen and a computing apparatus to which the method is applied.

However, It will be understood that aspects of the present disclosure are not restricted to the one set forth herein. The above and other aspects of the present disclosure will become more apparent to one of ordinary skill in the art to which the present disclosure pertains by referencing the detailed description of the present disclosure given below.

According to an aspect of an example embodiment of the disclosure, method for displaying an operation assistance screen for precision machining equipment being executed by a computing apparatus is provided. The method includes receiving user input to designate a region of interest and select one or more execution target recipes, the region of interest being at least a partial region of a display on which an operation user interface (UI) of the precision machining equipment is displayed, and the one or more execution target recipes being from among a plurality of previously generated recipes; capturing, in real time, an image of the region of interest on the display displaying the operation UI of the precision machining equipment; generating a real time assistance screen of the precision machining equipment based on the captured image of the region of interest and the execution target recipe; and displaying the generated real-time assistance screen on the display, wherein each of the execution target recipes includes one or more activities for generating real-time assistance output based on an input image and a predefined workflow, wherein the real-time assistance screen includes the real-time assistance output, and wherein the capturing the image, the generating the real time assistance screen, and the displaying the generated real-time assistance screen include no direct information exchange with a program associated with the operation UI of the precision machining equipment.

According to other aspect of an example embodiment of the disclosure, a non-transitory computer-readable medium storing one or more instructions for generating a real-time operation assistance screen for precision machining equipment are provided. The instructions when executed by one or more processors, cause a computing apparatus to: receive user input to designate a region of interest and select one or more execution target recipes, the region of interest being at least a partial region of a display on which an operation user interface (UI) of the precision machining equipment is displayed, and the one or more execution target recipes being from among a plurality of previously generated recipes; capture, in real time, an image of the region of interest on the display displaying the operation UI of the precision machining equipment; generate a real time assistance screen of the precision machining equipment based on the captured image of the region of interest and the execution target recipe; and display the generated real-time assistance screen on the display, wherein each of the execution target recipes includes one or more activities for generating real-time assistance based on an input image and a predefined workflow, wherein the real-time assistance screen includes real-time assistance output, and wherein the capturing the image, the generating the real time assistance screen, and the displaying the generated real-time assistance screen include no direct information exchange with a program associated with the operation UI of the precision machining equipment.

According to another aspect of an example embodiment of the disclosure, computing apparatus for controlling precision machining equipment is provided. The apparatus includes memory which loads an operation assistance screen display program of the precision machining equipment and at least one processor which executes the operation assistance screen display program of the precision machining equipment loaded into the memory. The operation assistance screen display program includes: receiving code configured to cause the at least one processor to receive user input to designate a region of interest and select one or more execution target recipes, the region of interest being at least a partial region of a display on which an operation user interface (UI) of the precision machining equipment is displayed, and the one or more execution target recipes being from among a plurality of previously generated recipes; capturing code configured to cause the at least one processor to capture, in real time, an image of the region of interest on the display displaying the operation UI of the precision machining equipment; generating code configured to cause the at least one processor to generate a real time assistance screen of the precision machining equipment based on the captured image of the region of interest and the execution target recipe; and displaying code configured to cause the at least one processor to display the generated real-time assistance screen on the display, wherein each of the execution target recipes includes one or more activities for generating real-time assistance output based on an input image and a predefined workflow, wherein the real-time assistance screen includes the real-time assistance output, and wherein the capturing the image, the generating the real time assistance screen, and the displaying the generated real-time assistance screen include no direct information exchange with a program associated with the operation UI of the precision machining equipment.

### BRIEF DESCRIPTION OF DRAWINGS

The above and other aspects and features of the present disclosure will become more apparent by describing in detail exemplary embodiments thereof referring to the attached drawings, in which:

FIG. 1 is a diagram showing an operation system of the precision machining equipment according to related art;

FIG. 2 is a diagram showing an exemplary operation UI provided by the operation program of the precision machining equipment according to related art;

FIG. 3 is a diagram showing an exemplary real-time assistance screen that may be displayed on a control computing apparatus of the precision machining equipment according to embodiments of the present disclosure;

FIG. 4 is a flowchart of a method for displaying an operation assistance screen of the precision machining equipment according to an embodiment of the present disclosure;

FIGS. 5 to 8 are diagrams showing exemplary real-time assistance screen generation UI that may be provided by a real-time assistance program in embodiments of the present disclosure;

FIG. 9 illustrates an automatic region of interest adjustment that may be assisted by a real-time assistance program in some embodiments of the present disclosure;

FIG. 10 is a diagram for explaining an exemplary UI of a recipe editor that may be provided by a real-time assistance program in some embodiments of the present disclosure;

FIGS. 11 and 12 are diagrams for illustrating an exemplary recipe that may be generated through some embodiments of the present disclosure; and

FIG. 13 is a configuration diagram of an exemplary computing apparatus that may be used in some embodiments of the present disclosure.

### DETAILED DESCRIPTION OF EMBODIMENTS

Hereinafter, example embodiments of the disclosure will be described with reference to the attached drawings. The advantages and features of the disclosure and methods of accomplishing the same would be understood more readily by reference to the following detailed description of example embodiments and the accompanying drawings. The disclosure may, however, be embodied in many different forms and should not be construed as being limited to the example embodiments set forth herein. Rather, these embodiments are provided so that this disclosure will be thorough and complete and will fully convey the concept of the disclosure to those skilled in the art, and the disclosure will be defined by the appended claims and their equivalents. In describing the disclosure, if it is determined that a detailed description of a related known configuration or function may obscure the gist of the disclosure, the detailed description will be omitted.

The singular expressions used in the following embodiments include plural concepts, unless the context clearly specifies singularity. Additionally, plural expressions include singular concepts, unless the context clearly specifies plurality. In addition, terms such as first, second, A, B, (a), (b) used in the following embodiments are only used to distinguish one element from another element, and the terms do not limit the nature, sequence, or order of the relevant elements.

The elements described with reference to terms such as unit, module, block, ~or, ~er, etc. used in the disclosure and the functional blocks shown in the drawings may be implemented in the form of software, hardware, or a combination thereof. For example, the software may be machine code, firmware, embedded code, and application software. For example, the hardware may include an electrical circuit, an electronic circuit, a processor, a computer, an integrated circuit, integrated circuit cores, passive components, or a combination thereof.

First, in some embodiments of the present disclosure, an exemplary real-time assistance screen that may be displayed on a control computing apparatus of the precision machining equipment. An example will be described referring to FIG. 3.

It may be understood that display devices 30 and 40 shown in FIG. 3 are display devices of a computing apparatus for controlling the precision machining equipment. Display devices 30 and 40 are connected to the precision machining equipment. That is, a user operates the precision machining equipment such as an FIB, while viewing an operation UI 100 of the operation program for the precision machining equipment displayed on the display device 30.

In the present disclosure, the precision machining equipment may be not only a FIB but also an EBL (Electron Beam Lithography), laser micromachining, a Computer Numerical Control (CNC) Ultra-Precision Machining, an EDM (Electrical Discharge Machining), Ion Beam Figuring (IBF) or SPM-based nanomachining (Scanning Probe Microscopy-based Nanomachining).

A real-time assistance screen 200 generated in some embodiments of the present disclosure may display an analysis of a screen of a designated region of interest in at least a partial region of the display 30 on which the operation UI 100 is displayed. In embodiments, the real-time assistance screen 200 may include a replication window 210 in which the region of interest is duplicated in real time.

The operation UI 100 may include a captured image monitoring panel, and the user may check the operation status and the current status of the specimen through the captured image displayed on the captured image monitoring panel through an enlarged image. When the region of interest is designated in a specific image of such a captured image monitoring panel, a specific image corresponding to the region of interest will be duplicated in the replication window 210 in real time.

The replication window 210 may include labeling information 220a and 220b about at least one of the specific coordinates of the region of interest and the specific region. The labeling information may be displayed in a box or another acceptable form that displays an outline of the specific region as shown in FIG. 3. For example, the labeling information may be displayed in a form that fills the specific region with a previously designated visual form, or may be displayed in the form of pointing a specific coordinate. The labeling information 220a and 220b may be displayed in a form that overlays on the region of interest duplicated in the replication window 210 in real time. Accordingly, the user may check real-time analytical information on a specific image displayed on the captured image monitoring panel of the operation UI 100 through the real-time assistance screen 200.

The real-time assistance screen 200 may further include a reference data window 230. The reference data window 230 may display one or more numerical values or texts that are output as a result of the analysis of the image of the region of interest.

It is important to understand that the real-time assistance screen 200 is not provided by the operation program of the precision machining equipment that provides the operation UI 100. That is, the operation program of the precision machining equipment and the real-time assistance program that provides the real-time assistance screen 200 are distinct entities and are executed separately. That is, in other words, the real-time assistance program is agnostic with respect to the operation assistance screen of the precision machining equipment. For example, the operation program and the real-time assistance program may be executed through separate processes from each other. The process may be understood as a process that is a unit scheduled by an operating system. In some other embodiments, the operation program and the real-time assistance program may be executed in separate containers from each other. The container may be understood to mean a virtualization technology that bundles an application and all elements required for the execution thereof into one package and enables it to be executed consistently in various environments.

That is, the real-time assistance program, which is a program separate from the operation program, provides the real-time assistance screen 200. Further, the real-time assistance program is not provided with an image of the region of interest from the operation program of the precision machining equipment to generate the real-time assistance screen 200. In addition, the real-time assistance program is not provided with an image of the region of interest from the precision machining equipment to generate the real-time assistance screen 200.

An another example, it will be understood that the operation program generates a control signal to be transmitted to the precision machining equipment and the operation program receives specimen captured images and machining-related information from the precision machining equipment. However, the operation program or the precision machining equipment not transmit or receive data or images to or from the real-time assistance program.

That is, the real-time assistance program is not limited in operation to when it receives any data or images from the precision machining equipment and the operation program for operating the precision machining equipment. Therefore, there is no dependency on the precision machining equipment and the operation program thereof.

The real-time assistance program may generate a real-time assistance screen for the image of the region of interest, by capturing an image of the region of interest in real time and inputting the captured image into the execution target recipe, but it does so without receiving any data or images from the precision machining equipment and the operation program for operating the precision machining equipment.

The operation of the real-time assistance program will be described in more detail below referring to the embodiments to be described below.

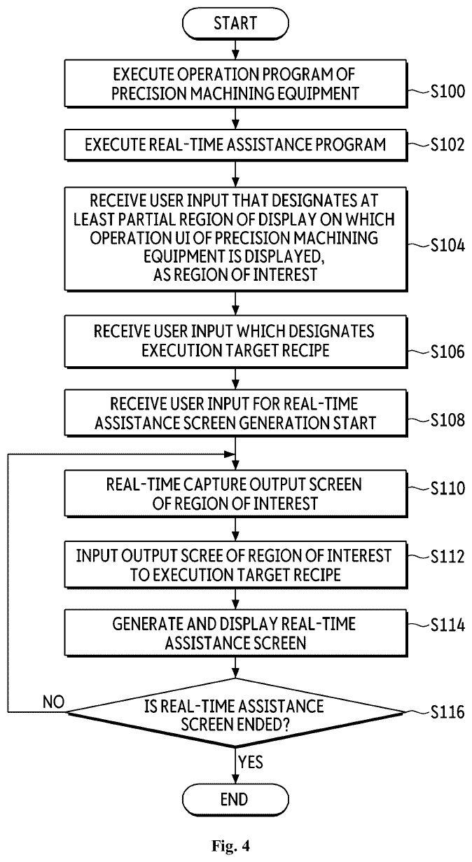

A method for displaying an operation assistance screen for precision machining equipment according to an embodiment of the present disclosure will be described referring to FIG. 4. It must be understood that this disclosure is not limited thereto.

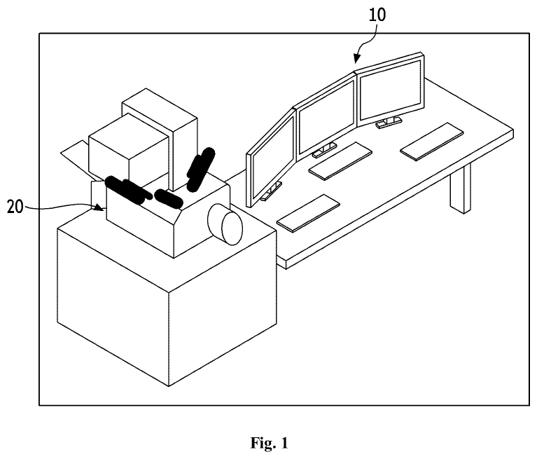

The method for displaying the operation assistance screen according to the present disclosure may be executed by a computing apparatus. The computing apparatus may be, for example, a computing apparatus for operating the precision machining equipment described with respect to FIG. 1.

First, the operation program and the real-time assistance program of the precision machining equipment are each executed in the computing apparatus (S100 and S102). Each may be executed as separate applications or instances by the computing apparatus. Next, the real-time assistance program may receive a user input for designating the region of interest (S104). The region of interest may be designated as at least a partial region on the display on which the operation UI 100 provided by the operation program is displayed.

Next, the real-time assistance program may receive a user input for designating an execution target recipe among a plurality of previously generated recipes (S106). The previously generated recipes may include at least some of those directly created and stored by the user of the real-time assistance program, those created by other users of the real-time assistance program, those created, downloaded, and distributed online.

The recipe may be generated previously before the user input for designating the execution target recipe is input by a recipe editor that generates a recipe on the basis of the user inputs for defining one or more activities and information paths.

The recipe may be made up of one or more activities for receiving input of a screen of the region of interest and generating a real-time assistance output by the use of the input screen of the region of interest. It will be understood that the recipe may be a workflow for processing the screen of the region of interest in some embodiments.

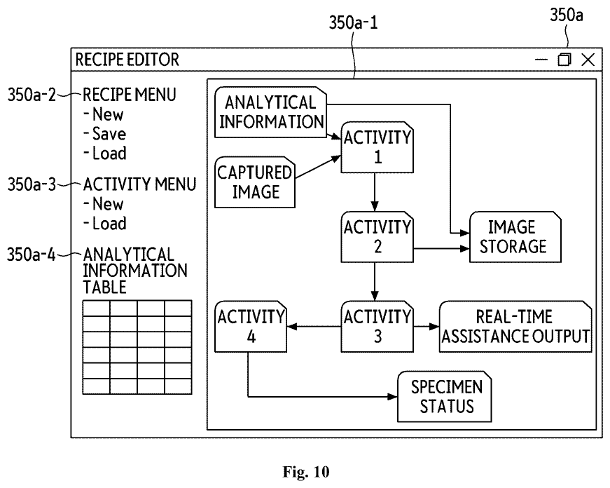

The recipe, which may be a workflow, may be made up of information paths between one or more activities, workflow inputs, and workflow outputs. The recipe may be edited by the recipe editor. The recipe editor assisting a user to directly create the recipe will be described below referring to FIGS. 10 to 12.

Among the workflow outputs of the recipe, data or information to be displayed on the real-time assistance screen will be called a real-time assistance output. The real-time assistance output may include labeling information that is displayed to overlay on the replication window 210 described referring to FIG. 3, and/or reference data that is displayed in the reference data window 230.

The user may input a real-time assistance screen generation start command to the real-time assistance program, thereby starting generation of the real-time assistance screen that displays a real-time assistance output generated by inputting the output screen of the designated region of interest into the execution target recipe (S108).

After that, the output screen of the region of interest may be captured in real time (S110). The real-time assistance program may acquire the output screen of the region of interest in real time, by performing the real-time capture of the region of interest. As a result, the real-time assistance program may acquire the image of the region of interest in real time without being provided with any data or image from the precision machining equipment and the operation program for operating the precision machining equipment. That is, there is no need for the real-time assistance program to exchange data directly with the precision machining equipment and the operation program for operating the precision machining equipment. In this context, “no direct exchange” means that the real-time assistance program does not receive raw data, metadata, or images via any programmatic interface, API call, or data link from the equipment or its operation program, but instead operates solely based on screen capture.

Next, the real-time assistance program may execute the execution target recipe by inputting the output screen of the region of interest acquired in real time into the execution target recipe (S112). Since the real-time assistance program is not a compiled program including the execution target recipe, the execution target recipe may be written in an interpreter language. Thus, the plurality of previously generated recipes may be written in the interpreter language. For example, the execution target recipe may be written in Python, JavaScript, or Matlab.

Next, the real-time assistance program generates a real-time assistance screen using the real-time assistance output that is output from the execution target recipe, and displays the generated real-time assistance screen (S114).

The real-time assistance program may refresh the real-time assistance screen, while repeating steps S110 to S114. That is, the real-time assistance screen may be updated in real time.

The user may obtain assistance information that is useful for operating the precision machining equipment through the real-time assistance screen updated in real time. For example, in a thin piece thinning process step of a thin piece manufacturing factory using an FIB, the user may easily determine whether to continue milling by referring to the real-time assistance output displayed on the real-time assistance screen. In the related art, the user had to decide whether to continue milling by the use of only the captured image of the specimen displayed by the operation UI of the precision machining equipment and limited analytical information. That is, in related art, there was considerable room for erroneous determination in this procedure. However, the likelihood of erroneous determination will be lowered when referring to the real-time assistance screen provided according to the present disclosure.

When it is no longer necessary for the user to execute the execution target recipe, the user may end the execution of the execution target recipe by inputting a real-time assistance screen end command to the real-time assistance program (S116). The user may input the real-time assistance screen end command even if the execution target recipe needs to be replaced because the operation of the precision machining equipment needs to proceed to the next step.

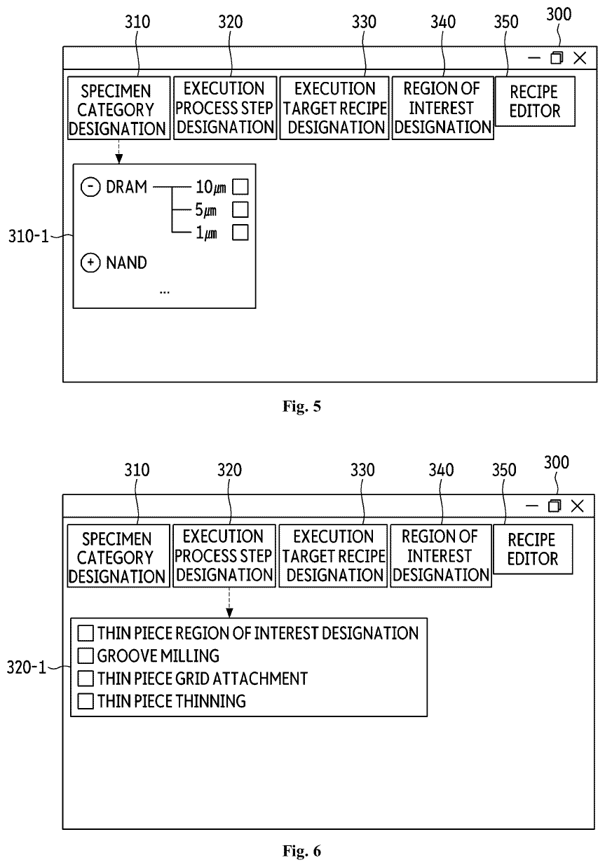

Hereinafter, in some embodiments of the present disclosure, the operation of the real-time assistance program will be described through an exemplary real-time assistance screen generation UI that may be provided by the real-time assistance program. As shown in FIG. 5, the real-time assistance screen generation UI 300 may include buttons 310, 320, 330, and 340 for receiving the user input for designating a generation method of the real-time assistance screen, and a recipe editor 350 for directly creating the recipe. The functions, algorithms, implementations, etc., of each of the buttons 310, 320, 330, and 340 will be described below.

When the category of the specimen designation button 310 is selected, a category of the specimen designation screen 310-1 for receiving the category to which the specimen belongs from the user may be displayed. The categories of the specimen may be configured in a hierarchical structure. For example, as shown in FIG. 5, the category of the specimen may refer to which product the specimen is related. The reason why it is necessary to designate a category of the specimen in real-time assistance screen generation is to filter recipes that are applicable to the designated specimen category among a plurality of previously designated recipes.

The user may further designate the execution process for the same reason as the designation of the category of the specimen. As shown in FIG. 6, when the execution process step designation button 320 is selected, an execution process step designation screen 320-1 is displayed. This screen may receive an identity of the execution process step that requires the real-time assistance screen generation from the user. For example, when manufacturing a thin piece using an FIB, the execution process step designation screen 320-1 may display a process step list including a thin piece region of interest designation process step, a groove milling process step, a thin piece grid attachment process step, and a thin piece thinning process step. The process step list may include additional steps added by an user. By selecting a currently ongoing process step on the execution process step designation screen 320-1, the user may designate an execution target recipe among recipes that are applicable to the currently ongoing process step when designating an execution target recipe, which will be described below.

When the execution target recipe designation button 330 is selected, a recipe list screen 330-1 may be displayed. The recipe list screen 330-1 may display a recipe list including at least some of recipes that are accessible by the computing apparatus. The recipe list may include at least some of recipes stored in a local repository of the computing apparatus, or may include at least some of recipes stored in a cloud repository of the computing apparatus.

Also, as described above, if a specimen category is designated (e.g., using button 310), the recipe list may include only recipes corresponding to the designated specimen category. Also, if the execution process step is designated (e.g., using button 320), the recipe list may include only recipes corresponding to the designated execution process step. Also, if the category of the specimen is designated and the execution process step is also designated, the recipe list may include only recipes corresponding to both the designated specimen category and the designated execution process step. For this purpose, each recipe may include corresponding specimen category information and corresponding execution process step information.

The recipe list screen 330-1 may include a check box 330-1a of the recipe, a button 330-1b for displaying the description of the recipe, and a button 330-1c (e.g., an edit button) for editing the recipe. When the button 330-1c for editing the recipe is selected, a recipe editor, which will be described below referring to FIGS. 10 to 12, will be displayed.

On the other hand, in some embodiments, as shown in FIG. 8, the recipe list screen 330-1 may display a recipe that does not correspond to the designated specimen category or the designated execution process step. However, a sign (X sign) indicating that the selection is not possible may be displayed in the check box 330-1a of the recipe. That way, a user knows that the recipe does not correspond to the designated specimen category or designated execution process step, and a popup message 330-1d that guides the reason why the selection is not possible may be displayed in response to the user's selection input.

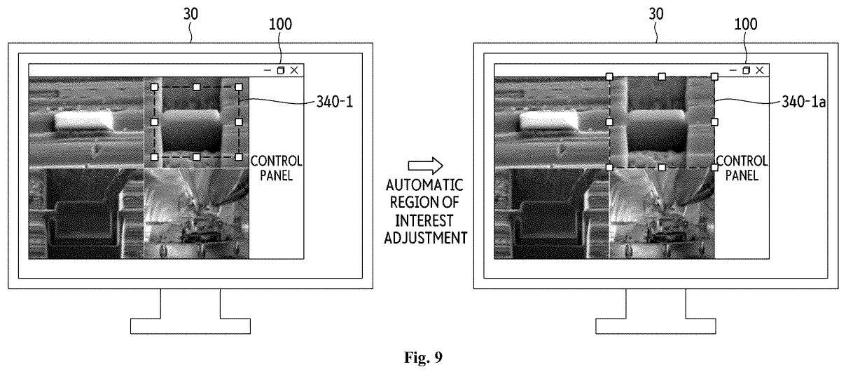

When the region of interest designation button 340 is selected, a control object 340-1 for designating the region of interest may be displayed as shown in FIG. 9. At this time, when the display region of the real-time assistance screen generation UI 300 may overlap with the operation UI 100 even partially so that the operation UI 100 may be completely displayed on the display 30, the display position of the real-time assistance screen generation UI 300 may be automatically moved and/or pushed to a lower display layer. It should be noted that the selection input region of interest designation button 340 does not have to be the first step of the process sequence, and such designation may be adjusted at any time according to the user's intention, thereby causing the captured image to vary accordingly. Furthermore, the real-time assistance program may be started or stopped through a dedicated button, for example, a button labeled as “start.”

The user may move the position of the control object 340-1 and designate the region of interest, using an upper boundary adjustment button, a left boundary adjustment button, a right boundary adjustment button or a lower boundary adjustment button of the control object 340-1.

However, since the region of interest is designated manually, a primitive region of interest 340-1 according to the user's input may be designated inaccurately. For example, as shown in FIG. 9, the primitive region of interest 340-1 may designate only an internal part of the captured image monitoring panel of the operation UI 100. In this case, even if the screen of the primitive region of interest 340-1 is input to the execution target recipe, an accurate real-time assistance output may not be generated. In order to improve this problem, in some embodiments, the real-time assistance program may provide an automatic region of interest adjustment function that may automatically select a complete region of interest. This automatic region of interest adjustment function will be able to automatically set an adjusted region of interest 340-1a as a result of automatic adjustment to the primitive region of interest 340-1.

In order to provide the above-mentioned automatic region of interest adjustment function, the real-time assistance program may determine, as the region of interest, the region of the main window included in the primitive region of interest corresponding to the user input for designating the region of interest. The region of the main window may be obtained by calling an application programming interface (API) of the operating system that returns information about the window object.

For example, when each captured image display region included in the captured image monitoring panel of FIG. 9 is formed by an invisible window, it may be understood that the window of the captured image display region included in the primitive region of interest 340-1 is the main window. The real-time assistance program may determine the region of the main window as the region of interest. That is, in embodiments, when the primitive region of interest 340-1 and the region of the main window are different from each other, the automatic region of interest adjustment function may be executed.

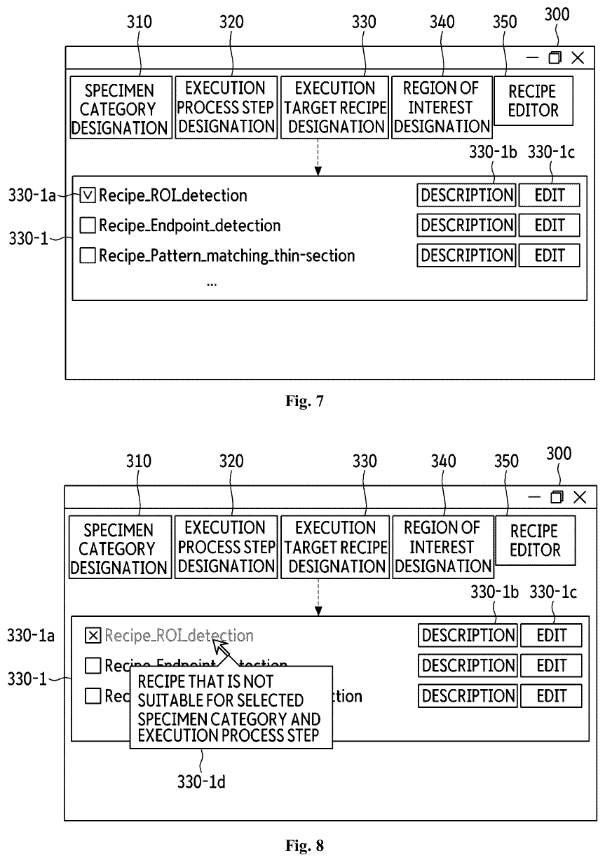

An exemplary UI of a recipe editor that may be provided to the real-time assistance program in some embodiments of the present disclosure will be described referring to FIG. 10. A recipe editor UI 350a shown in FIG. 10 may be displayed in response to a situation in which the recipe editor button 350 of the real-time assistance screen generation UI shown in FIGS. 5 to 8 is selected, or a button 330 for editing a recipe inside the execution target recipe list screen 330-1 shown in FIGS. 7 to 8 is selected.

The recipe editor UI 350a may include recipe menus 350a-2 including generation of a new recipe, storage of the recipe, and loading of the recipe, and activity menus 350a-3 including generation of a new activity and loading of a stored activity.

Furthermore, in some embodiments, the real-time assistance program may be provided with analytical information provided by the precision machining equipment or the operation program of the precision machining equipment. The recipe editor UI 350a may further display an analytical information table 350a-4 so that a recipe for receiving the provided analytical information may be created.

The recipe editor UI 350a may further include a draw panel 350a-1 for editing the workflow of the recipe to be created. A user may create the workflow, by placing an object indicating analytical information, an object indicating a screen of a real-time captured region of interest, an object indicating one or more activities, an object indicating a workflow output, and an arrow indicating an information flow between each object, on the draw panel 350a-1.

The object indicating the workflow output may include, for example, an object for storing a screen of the region of interest, and an object for formatting the status of a specimen to data of a previously designated format and then exporting it to a previously designated route.

Furthermore, the user may place the object indicating the analytical information, the object indicating a screen of the region of interest captured in real time, or the object indicating one or more activities, on the draw panel 350a-1 in a drag-and-drop manner. For this purpose, the object indicating the screen of the region of interest captured in real time or the object indicating each activity may be displayed in an object panel disposed outside the draw panel 350a-1. The user may drag-and-drop the object displayed in the object panel to the draw panel 35. Furthermore, in some embodiments, the user may place analytical information displayed in the analytical information table 350-4 on the draw panel 350a-1 in a drag-and-drop manner.

As described above, each recipe may be written in an interpreter language. This eliminates the need for a real-time assistance program to be recompiled to include a specific recipe in order to execute a specific recipe. This improves the efficiency of the real-time assistance program, and therefore, improves the operation of the precision machining equipment.

Furthermore, the user may realize the recipe desired by the user with a high degree of freedom, by directly compiling each activity into an interpreter language. The interpreter language may be, for example, Python. For example, the recipe editor 350a may display a source code editing window of the selected activity in response to the user selection of the activity located on the draw panel 350a-1. For example, the user may right-click the object of the activity located on the draw panel 350a-1 to open the source code editing window and realize the behavior of the activity in an interpreter language.

In some embodiments, the recipe editor 350a may display, in the source code editing window, a template source code that includes, among other things, syntax corresponding to the input object and syntax corresponding to the output object. Other elements may also be included that reflect the input object and output object for the selected activity defined through the draw panel 350a-1.

The real-time assistant program must be able to execute the recipe, and each activity may be forced to include at least one method and at least one class including the method. In some embodiments, the recipe editor 350a may output an error indication, when the source code which is input to the source code editing window that does not include one method and one class including the method.

When the recipe includes at least one method and at least one class including the method, the real-time assistant program may determine the execution order of the activities according to the information path of the recipe, and reliably execute the recipe by calling one method of each activity according to the execution order of the activities.

The class corresponding to each activity may have plurality of instance variables, and the plurality of instance variables may be variables to which input values for the recipe or outputs of the recipe are set. For example, the class of the first activity may set data in a first variable among a plurality of instance variables, and the class of the second activity may read the data stored in the first variable. Accordingly, a data may be transferred between the first activity and the second activity. The data may be a numerical value, a text, an image, or a moving image.

When the precision machining equipment is an FIB, in some embodiments, the recipe editor 350a may further include a region including a control object for designating a target specimen category corresponding to the recipe to be created, and a target execution process that is any one of a plurality of processes included in the thin piece manufacturing. For example, the user may designate the target specimen category corresponding to the recipe created in the recipe editor 350a as a V-NAND (Vertical-NAND) product of a first specification, and designate the process as a thin piece region of interest designation process. Information on the recipe designated by the user in this manner may be stored as meta information of the created recipe so that it may be used as reference information on filtering which is targeted at the plurality of recipes when designating the execution target recipe as described above. In addition, the recipe editor 350a may display a recommended activity corresponding to at least one of the target specimen category and the target execution process designated by the user.

The recipe editor 350a may select some of the activities for which the number of activity applications exceeds a reference value for each target specimen category as the recommended activity. In embodiments, the recipe editor 350a may select some of the activities for which the number of activity applications exceeds the reference value for each target execution process, by the use of the meta information of a plurality of recipes stored in advance. The user may shorten the time required to create a recipe, using the recommended activity recommended by the recipe editor 350a.

When manufacturing the thin piece using the FIB, the thin piece may be manufactured through a process of designating the region of interest for manufacturing the thin piece on a specimen, a groove machining process, a process of attaching the thin piece to a grid, and a process of thinning the thin piece.

In some embodiments, the recipe corresponding to the process steps, i.e., thin piece region of interest designation, groove milling, thin piece grid attachment, thin piece thinning, and additional steps, comprises image processing activities based on computer vision techniques. The image processing activities may include built-in tools and user-added tools. The built-in tools may include tools for, for example, a line profiling activity, an angle measurement activity, an image binarization activity, and an image template matching activity. The user-added tools may be tools for activities, the tools being plugged in by a user and coded in an interpreter language such as Python or JavaScript. An end-point detection activity may be an example of an activity using or based on a user-added tool. Some of the user-added tools, such as the end-point detection activity, may incorporate a pre-trained AI model. The recipe editor may support interpreter languages and may import functions coded in Python or JavaScript.

In some embodiments, the recipe may read and/or load one or more files required for execution. The assistance recipe may also store output data, such as a text file, an analyzed image, a reference image, or other files necessary for execution of the recipe.

In instances where the recipe corresponds to the thin piece region of interest designation, an image binarization activity and a line profiling activity may be included. In other words, in some embodiments, the recipe editor 350a may display the image binarization activity and the line profiling activity as recommended activities, when the target execution process is designated as the thin piece region of interest designation. The image binarization activity may be an activity that performs the operation of binarizing an image. The line profiling activity may be an activity that performs the line profiling, which is a technique of analyzing changes in pixel values along specific lines of the image to grasp a boundary, a contour or a structural feature of the image.

When the recipe corresponds to the groove milling, an end-point detection activity may be included. In other words, in some embodiments, the recipe editor 350a may display the end-point detection activity as a recommended activity, when the target execution process is designated as the groove milling. The end-point detection activity may be an activity that identifies a linear structure of the digital image or a start point and an end point of the contour line.

When the recipe corresponds to the thin piece thinning, a two-dimensional image pattern matching activity may be included. This is because, by comparing the cross-sectional image of the thin piece with the target pattern image to be checked in the thin piece in the thin piece thinning procedure, it is effective in preventing failure of the thin piece thinning procedure to interrupt the milling process, when the similarity between the cross-sectional image of the thin piece and the target pattern image exceeds a reference value. In other words, in some embodiments, the recipe editor 350a may display the two-dimensional image pattern matching activity as the recommended activity, when the target execution process is designated as the thin piece thinning.

The two-dimensional image pattern matching activity may be an activity that receives the thin piece cross-sectional image received from an analysis request system and the screen of the region of interest, and generates an output related to the similarity between the screen of the region of interest and the thin piece cross-sectional image. The analysis request system may be an external system which is connected to the control computing apparatus of the precision machining equipment through a network. It may also include transmitting analysis request information including data on the analysis target specimen and information on the analysis target requirements to the control computing apparatus.

At least some of the aforementioned activities may use an pre-trained AI model.

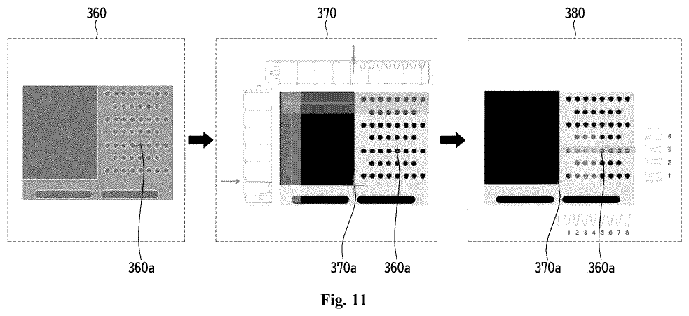

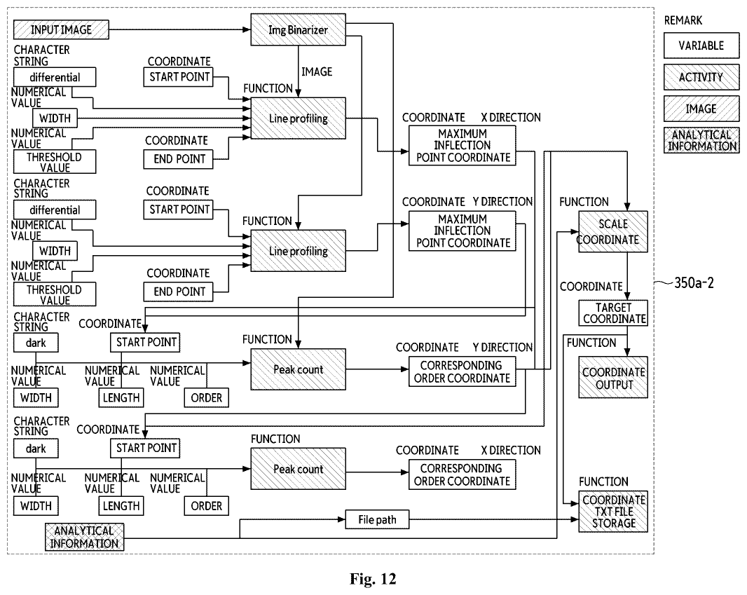

Hereinafter, an exemplary recipe that may be generated through some embodiments of the present disclosure to generate the real-time assistance screen for thin piece manufacturing using the FIB will be described referring to FIGS. 11 to 12.

FIG. 11 is a diagram illustrating the workflow of an exemplary recipe for generating the real-time assistance screen that may be useful in the process of designating a thin piece region of interest. When a user generates a thin piece corresponding to the analysis request information that checks a cross section of a hole 360a located at the fifth position on the right side and the third position from the top among the holes disposed in a grid shape included in the specimen 360, a recipe may perform an operation 370 of identifying the reference position 370a of the grid-shaped arrangement of holes through primary line profiling, and an operation 380 of identifying the target hole 360a through secondary line profiling which uses the reference position 370a as the reference point. This may help the user to accurately and quickly determine the thin piece region of interest. Further, it may be performed and/or displayed to the user through the real-time assistance screen and/or program.

FIG. 12 is an exemplary workflow 350a-2 for realizing the exemplary recipe described through FIG. 11. The exemplary workflow shown in FIG. 12 may be created, using the recipe editor 350a described referring to FIG. 10.

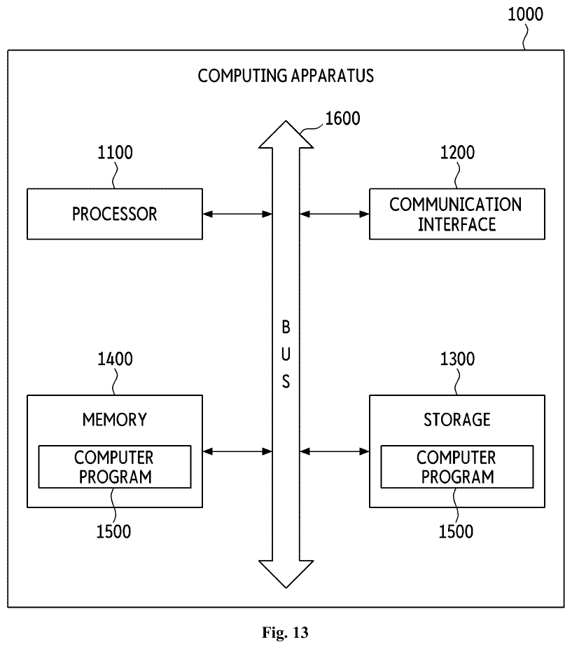

FIG. 13 is a configuration diagram of an exemplary computing apparatus that may be used in some embodiments of the present disclosure.

A computing system 1000 of FIG. 13 may be, for example, a control computing apparatus of the precision machining equipment described above. The computing system 1000 may include one or more processors 1100, a system bus 1700, a communication interface 1200, a memory 1400 that loads a computer program 1500 to be executed by the processor 1100, and a storage 1300 that stores the computer program 1500.

The computing system 1000 may be provisioned through a cloud service, and in this case, the one or more processors 1100, the communication interface 1200, the memory 1400, and the storage 1300 may all be virtualized resources. The storage 1300 may also store the computer program 1500.

The processor 1100 controls the overall operation of each component of the computing system 1000. The processor 1100 may perform computation on at least one application or program for executing method/operation according to various examples of the present disclosure. The memory 1400 stores various types of data, instructions and/or information. The memory 1400 may load one or more computer programs 1500 from the storage 1300 to execute methods/operations according to various examples of the present disclosure. The system bus 1700 provides a communication function between components of the computing system 1000. The communication interface 1200 supports Internet communications of the computing system 1000. The storage 1300 may non-temporarily store one or more computer programs 1500.

The computer program 1500 may include one or more instructions in which methods/operations according to various examples of the present disclosure are implemented. When the computer program 1500 is loaded into the memory 1400, the processor 1100 may perform methods/operations according to various examples of the present disclosure by executing one or more instructions.

The computer program 1500 may include an instruction for designating a region of interest, which is at least a partial region of a display on which an operation UI (User Interface) of the precision machining equipment is displayed, and one or more execution target recipes among a plurality of previously generated recipes, on the basis of a user input, an instruction for capturing an output screen of the designated region of interest in real time, an instruction for generating a real-time assistance screen of the precision machining equipment by inputting the screen of the region of interest captured in real time into the execution target recipe, and an instruction for displaying the real-time assistance screen. Each of the recipes is made up of one or more activities for generating the real-time assistance output by processing the input image according to a previously defined workflow, and the real-time assistance screen may include the real-time assistance output generated by the execution target recipe.

Although the embodiments of the present disclosure have been described with reference to the accompanying drawings, it will be apparent to those skilled in the art that the present disclosure may be fabricated in various forms without being limited to the above-described embodiments and may be embodied in other specific forms without departing from the technical spirits and essential characteristics. Thus, the above embodiments are to be considered in all respects as illustrative and not restrictive.

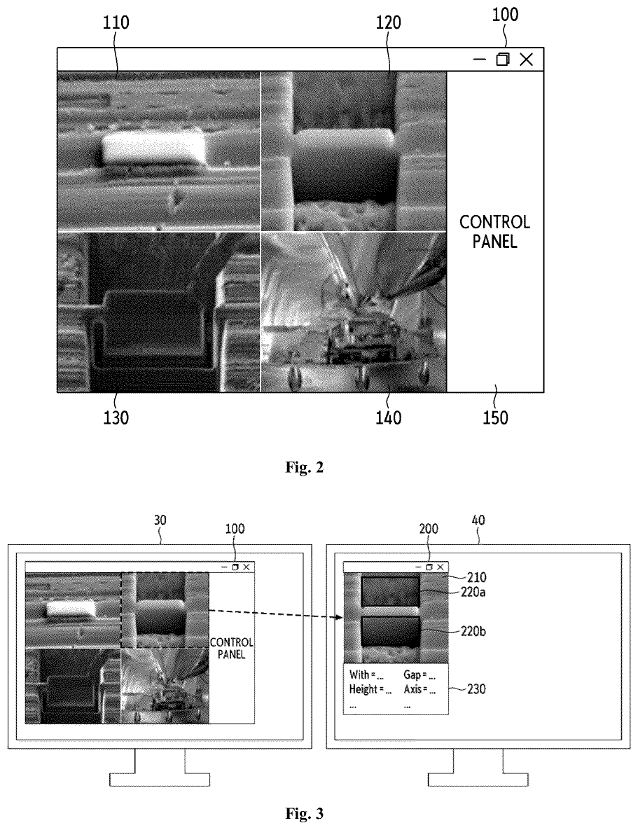

Various example embodiments of the disclosure and effects according to the example embodiments have been described with reference to FIGS. 1 to 13. The effects according to the technical idea of the disclosure are not limited to the effects mentioned above, and other effects not described may be clearly understood by those skilled in the art from the description above.

The technical ideas of the disclosure described so far may be implemented as computer-readable code on a computer-readable medium. The computer program recorded on the computer-readable recording medium may be transmitted to another computing device through a network such as the Internet, installed on the other computing device, and thus used on the other computing device.

Although operations are shown in a specific order in the drawings, it should not be understood that desired results may be obtained when the operations must be performed in the specific order or sequential order or when all of the operations must be performed. In certain situations, multitasking and parallel processing may be advantageous. Although embodiments of the disclosure have been described above with reference to the attached drawings, those skilled in the art will understand that the disclosure may be implemented in other specific forms without changing the technical idea or essential features. The example embodiments described above should be understood in all respects as illustrative and not restrictive. The scope of protection of the disclosure should be interpreted in accordance with the claims below, and all technical ideas within the equivalent scope should be construed as being included in the scope of rights of the technical ideas defined by this disclosure.

What is claimed is:

1. A method for generating a real-time operation assistance screen for precision machining equipment, the method being executed by one or more processors of a computing apparatus, and the method comprising:
receiving user input to designate a region of interest and select one or more execution target recipes, the region of interest being at least a partial region of a display on which an operation user interface (UI) of the precision machining equipment is displayed, and the one or more execution target recipes being from among a plurality of previously generated recipes;
capturing, in real time, an image of the region of interest on the display displaying the operation UI of the precision machining equipment;
generating a real time assistance screen of the precision machining equipment based on the captured image of the region of interest and the execution target recipe; and
displaying the generated real-time assistance screen on the display,
wherein each of the execution target recipes comprises one or more activities for generating real-time assistance output based on an input image and a predefined workflow,
wherein the real-time assistance screen comprises the real-time assistance output, and
wherein the capturing the image, the generating the real time assistance screen, and the displaying the generated real-time assistance screen comprise no direct information exchange with a program associated with the operation UI of the precision machining equipment.

2. The method of claim 1,
wherein the plurality of previously generated recipes are generated before receiving the user input based on a recipe editor, the recipe generator generating a recipe based on user inputs providing one or more activities and one or more information paths.

3. The method of claim 2,
wherein the recipe editor comprises a source code editing window for editing source code written in an object-oriented programming language for the one or more activities or the one or more information paths.

4. The method of claim 3,
wherein an activity comprises at least one method and at least one class comprising the at least one method, and
wherein the generating of the real-time assistance screen comprises:
determining an order of performing the one or more activities based on the one or more information paths; and
calling the at least one method of each activity based on the order of performing the one or more activities.

5. The method of claim 2,
wherein the precision machining equipment is a focused ion beam (FIB), and
wherein the recipe editor comprises a first region for designating a target specimen category of the recipe to be generated, and a second region for designating a target execution process step, the target execution step being one of a plurality of process steps comprised in thin piece manufacturing.

6. The method of claim 5,
wherein the recipe editor comprises an activity recommendation corresponding to at least one of the target specimen category and the target execution process step.

7. The method of claim 1,
wherein the receiving the user input comprises receiving a first user input for designating the region of interest and a second user input for designating the execution target recipe through a real-time assistance program that provides a configuration UI of the real-time assistance screen, and
wherein the real-time assistance program is executed through an instance separate from an operation program that provides the operation UI.

8. The method of claim 7,
wherein the capturing the image, the generating the real time assistance screen, and the displaying the generated real-time assistance screen are performed by the real-time assistance program.

9. The method of claim 7,
wherein the receiving user input comprises:
receiving of a third user input for designating a category of a specimen that is an operation target of the precision machining equipment;
displaying recipes corresponding to the designated specimen category on an execution target recipe selection control comprised in the configuration UI; and
receiving a fourth user input for designating the at least one execution target recipe among the recipes displayed.

10. The method of claim 7,
wherein the precision machining equipment is a Focused Ion Beam (FIB),
wherein the receiving user input comprises:
receiving a fifth user input for designating an execution process step, which is one of a plurality of process steps included in thin piece manufacturing;
displaying recipes corresponding to the designated execution process step on the display; and
receiving the fourth user input for designating the at least one execution target recipe among the recipes displayed,
wherein the recipes displayed correspond to the designated specimen category comprises:
displaying the recipes corresponding to the designated execution process step.

11. The method of claim 10,
wherein the plurality of process steps comprise a thin piece region of interest designation, groove milling, a thin piece grid attachment, and thin piece thinning, and
wherein the recipe corresponding to the thin piece region of interest designation comprises an image binarization activity and a line profiling activity.

12. The method of claim 10,
wherein the plurality of process steps comprise a thin piece region of interest designation, groove milling, a thin piece grid attachment, and thin piece thinning, and
wherein the recipe corresponding to the groove milling comprises an end-point detection activity.

13. The method of claim 10,
wherein the plurality of process steps comprise a thin piece region of interest designation, groove milling, a thin piece grid attachment, and thin piece thinning, and
wherein the recipe corresponding to the thin piece thinning comprises a two-dimensional image pattern matching activity.

14. The method of claim 13,
wherein the two-dimensional image pattern matching activity is an activity that:
receives an input of a thin piece cross-sectional image from an analysis request system and a screen of the region of interest, and
generates an output related to a similarity between the captured image of the region of interest and the thin piece cross-sectional image.

15. The method of claim 7,
wherein the receiving user input further comprises:
determining a region of a main window included in a primitive region of interest corresponding to the user input for designating the region of interest, as the region of interest,
wherein the primitive region of interest and the region of the main window are different from each other.

16. The method of claim 7,
wherein the operation program generates a control signal to be transmitted to the precision machining equipment, and receives a captured image of a specimen and machining-related information from the precision machining equipment, and
wherein the real-time assistance program does not transmit or receive data or image to or from the precision machining equipment and the operation program.

17. The method of claim 1,
wherein the real-time assistance output includes a first assistance output that includes labeling information for at least one of specific coordinates of the region of interest and a specific region, and
wherein the real-time assistance screen comprises a replication window in which an image of the region of interest that is overlaid with the first assistance output is displayed in real time.

18. The method of claim 17,
wherein the real-time assistance output further includes a second assistance output, and
wherein the real-time assistance screen further comprises a reference data window which is arranged adjacent to the replication window and includes the second assistance output.

19. A non-transitory computer-readable medium storing instructions for generating a real-time operation assistance screen for precision machining equipment, the instructions when executed by one or more processors, cause a computing apparatus to:
receive user input to designate a region of interest and select one or more execution target recipes, the region of interest being at least a partial region of a display on which an operation user interface (UI) of the precision machining equipment is displayed, and the one or more execution target recipes being from among a plurality of previously generated recipes;
capture, in real time, an image of the region of interest on the display displaying the operation UI of the precision machining equipment;
generate a real time assistance screen of the precision machining equipment based on the captured image of the region of interest and the execution target recipe; and
display the generated real-time assistance screen on the display,
wherein each of the execution target recipes comprises one or more activities for generating real-time assistance output based on an input image and a predefined workflow,
wherein the real-time assistance screen comprises the real-time assistance output, and
wherein the capturing the image, the generating the real time assistance screen, and the displaying the generated real-time assistance screen comprise no direct information exchange with a program associated with the operation UI of the precision machining equipment.

20. A computing apparatus for controlling precision machining equipment, comprising:
memory which loads an operation assistance screen display program of the precision machining equipment; and
at least one processor which executes the operation assistance screen display program of the precision machining equipment loaded into the memory,
wherein the operation assistance screen display program comprises:
receiving code configured to cause the at least one processor to receive user input to designate a region of interest and select one or more execution target recipes, the region of interest being at least a partial region of a display on which an operation user interface (UI) of the precision machining equipment is displayed, and the one or more execution target recipes being from among a plurality of previously generated recipes;
capturing code configured to cause the at least one processor to capture, in real time, an image of the region of interest on the display displaying the operation UI of the precision machining equipment;
generating code configured to cause the at least one processor to generate a real time assistance screen of the precision machining equipment based on the captured image of the region of interest and the execution target recipe; and
displaying code configured to cause the at least one processor to display the generated real-time assistance screen on the display,
wherein each of the execution target recipes comprises one or more activities for generating real-time assistance output based on an input image and a predefined workflow,
wherein the real-time assistance screen comprises the real-time assistance output, and
wherein the capturing the image, the generating the real time assistance screen, and the displaying the generated real-time assistance screen comprise no direct information exchange with a program associated with the operation UI of the precision machining equipment.
